(19) United States
(12) Patent Application Publication
(10) Pub. No.: US 2019/0174222 A1
(43) Pub. Date: Jun. 6, 2019

(54) NOISE REDUCTION METHOD AND DEVICE FOR SELF-ADAPTIVELY ADJUSTING NOISE REDUCTION GAIN, AND NOISE REDUCTION EARPHONE

(71) Applicant: GOERTEK INC., Weifang City, Shandong (CN)

(72) Inventors: Yupei LUO, Weifang City, Shandong (CN); Jin ZHANG, Weifang City, Shandong (CN); Kaizhao LIN, Weifang City, Shandong (CN)

(73) Assignee: Goertek Inc., Weifang City, Shandong (CN)

(21) Appl. No.: 16/304,570

(22) PCT Filed: Dec. 20, 2016
(86) PCT No.: PCT/CN2016/110992

§ 371 Date: Nov. 26, 2018

(30) Foreign Application Priority Data
May 30, 2016 (CN) 201610373999.3

(51) Int. Cl. H04R 1/10

(52) U.S. Cl. CPC H04R 1/1083; H04R 2460/01; H04R 1/1041

(57) ABSTRACT

The present invention discloses a noise-reduction method and device for self-adaptively adjusting a noise reduction gain, and a noise reduction earphone. The method includes: receiving a voice signal collected by a microphone installed on an earphone receiver as a noise signal; obtaining a current noise level of an external environment according to a current sound intensity of the noise signal; setting a current noise reduction gain value corresponding to a current noise level; and performing a noise reduction processing on the noise signal according to a current noise reduction gain value. The present invention sets a noise reduction gain value corresponding to a current noise level of an external environment according to the current noise level, which enables the noise-reduction earphone to adaptively adjust a noise reduction gain and effectively improves the user experience.

### FIELD OF THE INVENTION

The present invention relates to the field of earphone noise reduction, and more particularly, to a noise reduction method and device for adaptively adjusting a noise reduction gain and a noise reduction earphone.

### BACKGROUND OF THE INVENTION

Existing active noise reduction earphones achieve the effect of noise reduction by generating an anti-phase sound wave equal to ambient noise by using a noise reduction system and using the anti-phase sound wave to neutralize noise in the voice signal heard by ears. The principle of the noise reduction earphones is: a signal microphone placed in the earphone first detects noise in an environment that that can be heard by ears, then transmits the noise signal to a control circuit, the control circuit performs a real-time calculation, and transmits a sound wave with an opposite phase and a same amplitude relative to the noise via a speaker to resist the noise and cause the noise to disappear.

There are three types of existing active noise reduction earphones. The first type of active noise cancelling earphone realizes noise reduction by manually turning on a noise reduction switch, and a noise reduction gain is fixed. The second type of active noise cancelling earphone adjusts a noise reduction gain by using a touch button. The third type of active noise cancelling earphone adjusts a noise reduction gain by using a noise reduction application on a mobile phone. For the first type of active noise reduction earphone, a noise reduction function needs to be manually implemented. For different environments and different ambient noises, a noise cancellation effect remains unchanged, long-term wearing will produce a strong pressure on eardrums, and the power consumption is always high, which is not conducive to stay standby for a long time and is not energy-saving.

For the second type of active noise reduction earphone, the noise reduction gain can be adjusted, resolving power consumption and wearing comfort issues, but the noise reduction gain needs to be adjusted using a touch button of the earphone, which is prone to mis-operations, and brings poor use experience.

For the third type of active noise reduction earphone, a noise reduction gain can also be adjusted, resolving the power consumption and wearing comfort issues. However, it is necessary to enter the application on a mobile phone to slide to adjust the noise reduction effect. The adjustment relies on the mobile phone, and the application needs to be installed on different mobile phones to realize the function of adjustable noise reduction.

### SUMMARY OF THE INVENTION

An object of the present invention is to provide a new technical solution of a noise reduction earphone capable of smartly adjusting a noise reduction gain.

According to a first aspect of the present invention, there is provided a noise reduction method for adaptively adjusting a noise reduction gain, including:

receiving a voice signal collected by a microphone installed on an earphone receiver as a noise signal;

obtaining a current noise level of an external environment according to a current sound intensity of the noise signal;

setting a current noise reduction gain value corresponding to the current noise level; and

performing a noise reduction processing on the noise signal according to the current noise cancellation gain value.

Optionally, determining a current noise level of an external environment according to a current sound intensity of the noise signal includes:

comparing the current sound intensity of the noise signal with a set value reflecting a noise level, to obtain a comparison result; and

obtaining the current noise level of the external environment according to the comparison result.

Optionally, the method further includes:

determining, according to the current noise level, whether to perform noise reduction processing or not, if yes, setting the noise reduction gain value corresponding to the current noise level.

Optionally, setting a current noise reduction gain corresponding to the current noise level includes:

searching a comparison table that reflects correspondence relationship between a noise level and a noise reduction gain value, to obtain the noise cancellation gain value corresponding to the current noise level; and

setting the current noise reduction gain value to be equal to the determined noise reduction gain value.

According to a second aspect of the present invention, there is provided a noise reduction device for self-adaptively adjusting a noise reduction gain, including:

a receiving module, configured to receive a voice signal collected by a microphone installed on an earphone receiver as a noise signal;

a level obtaining module, configured to obtain a current noise level of an external environment according to a sound intensity of the noise signal;

a setting module, configured to set a current noise reduction gain value corresponding to the current noise level; and

a noise reduction processing module, configured to perform noise reduction processing on the noise signal according to the current noise reduction gain value.

Optionally, the level obtaining module includes:

a comparison unit, configured to compare the current sound intensity of the noise signal with a set value reflecting a noise level, to obtain a comparison result; and

an obtaining unit, configured to obtain the current noise level of the external environment according to the comparison result.

Optionally, the device further includes:

a determining module, configured to determine, according to the current noise level, whether to perform noise reduction processing.

Optionally, the setting module includes:

a searching unit, configured to search a correspondence table that reflects a correspondence between a noise level and a noise reduction gain value, to obtain the noise reduction gain value corresponding to the current noise level; and

a setting unit, configured to set the current noise reduction gain value to be equal to the obtained noise reduction gain value.

According to a third aspect of the present invention, there is provided a noise cancelling earphone, including the above noise reduction device for adaptively adjusting a noise reduction gain.

According to a fourth aspect of the present invention, there is provided a noise cancelling earphone, including a processor and a memory, where the memory is configured to store instructions, and the instructions are used to control the processor to operate to execute the noise reduction method for adaptively adjusting a noise reduction gain.

The inventor of the present invention finds that in the prior art, there is a problem that a noise reduction gain of an active noise cancelling earphone cannot be adaptively adjusted. In the embodiments of the present invention, a noise reduction gain value corresponding to a current noise level of an external environment is set according to the current noise level, which enables a noise cancelling earphone to adaptively adjust a noise reduction gain and effectively improves the user experience. Therefore, the technical task to be completed or the technical problem to be resolved by the present invention has not been contemplated or expected by those skilled in the art, and therefore the present invention is a new technical solution.

Further features of the present invention, as well as advantages thereof, will become apparent from the following detailed description of exemplary embodiments of the present invention with reference to the accompanying drawings.

### BRIEF DESCRIPTION OF THE DRAWINGS

The accompanying drawings, which are incorporated in and constitute a part of the specification, illustrate embodiments of the present invention and, together with the description, serve to explain the principles of the present invention.

FIG. 1 is a flowchart of an implementation manner of a method for adaptively adjusting a noise reduction gain according to the present invention;

FIG. 2 is a flowchart of an implementation manner of a step of obtaining a current noise level of an external environment according to the present invention;

FIG. 3 is a flowchart of an implementation manner of a step of noise reduction processing according to the present invention;

FIG. 4 is a schematic block diagram of an implementation structure of a device for adaptively adjusting a noise reduction gain according to the present invention;

FIG. 5 is a schematic diagram of an implementation structure of a noise cancelling earphone according to the present invention;

FIG. 6 is a schematic structural diagram of an implementation structure of a main control board of a noise cancelling earphone according to the present invention; and

FIG. 7 is a schematic structural diagram of an implementation structure of an earphone receiver of a noise cancelling earphone according to the present invention.

### DESCRIPTION OF REFERENCE NUMERALS

1—earphone interface; 2—main control board;

3—call microphone; 4—earphone receiver;

SPK—speaker; MIC—noise reduction microphone;

IC1—processor; IC2—noise reduction control chip.

### DETAILED DESCRIPTION OF THE EMBODIMENTS

Various exemplary embodiments of the present invention will now be described in detail with reference to the accompanying drawings. It should be noted that the relative arrangement of the components and steps, numerical expressions, and numerical values set forth in these embodiments do not limit the scope of the present invention unless specifically stated otherwise.

The following description of at least one exemplary embodiment is merely illustrative in nature and by no means is to be construed as any limitation to the invention and its application or use.

Techniques, methods, and devices known to one of ordinary skill in the relevant art may not be discussed in detail but, where appropriate, the techniques, methods, and devices should be considered part of the description.

In all of the examples shown and discussed herein, any specific value should be interpreted as merely illustrative and not as a limitation. Therefore, other examples of the exemplary embodiments may have different values.

It should be noted that like reference numbers and letters designate similar items in the following figures; therefore, an item need not be further discussed in subsequent figures once the item is defined in a figure.

The invention resolves the existing problem that a noise reduction gain of an active noise cancelling earphone cannot be adaptively adjusted, and provides a new technical solution for adaptively adjusting a noise reduction gain to cancel noise.

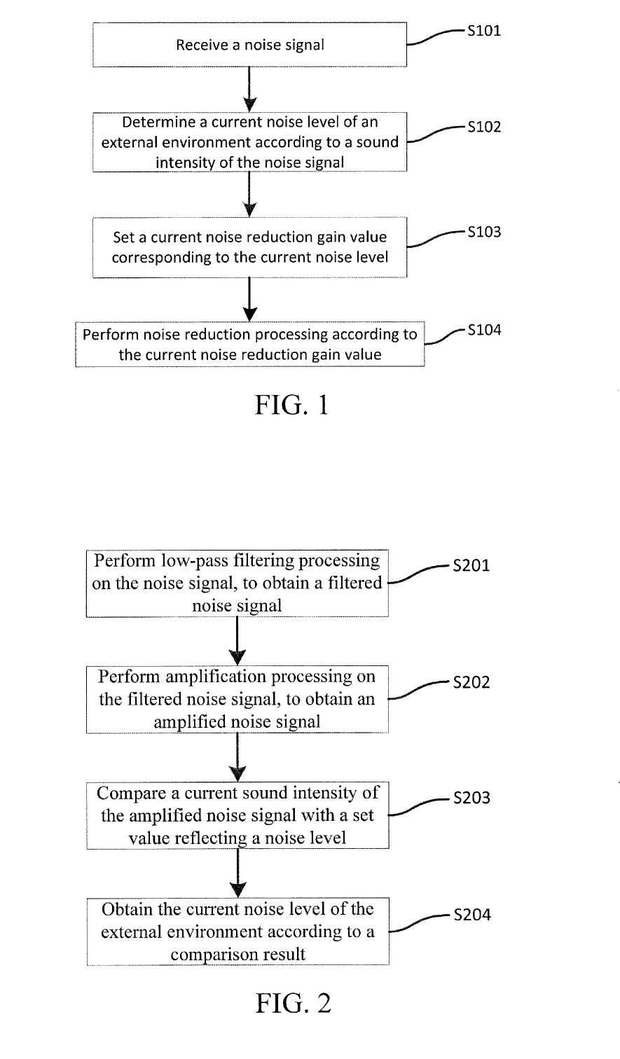

FIG. 1 is a flowchart of an implementation manner of a noise reduction method for adaptively adjusting a noise reduction gain according to the present invention.

According to FIG. 1, the method includes the following steps.

Step S101: Receive a voice signal collected by a microphone installed on an earphone receiver as a noise signal.

A noise cancelling earphone generally has two earphone receivers, and either or both of the earphone receivers may be mounted with a microphone (respectively).

If only one microphone is installed on the two earphone receivers, a voice signal collected by the microphone is received as a noise signal.

If both the earphone receivers are provided with microphones, a voice signal collected by a microphone installed on one earphone receiver may be received as a first noise signal; a voice signal collected by a microphone installed on the other earphone may be received as a second noise signal.

Step S102: Obtain a current noise level of an external environment according to a sound intensity of the noise signal.

An example in which both the earphone receivers are provided with microphones is used as an example below.

Specifically, corresponding current noise levels may be obtained according to current sound intensities of the first noise signal and the second noise signal respectively, to obtain a first noise reduction gain and a second noise reduction gain. Alternatively, a current noise level of an external environment may be obtained according to only the current sound intensity of the first noise signal, to obtain a noise reduction gain. Taking the latter as an example, a specific method for obtaining a current noise level of an external environment according to a current sound intensity of the noise signal may be specifically as follows:

comparing the current sound intensity of the first noise signal with a set value reflecting a noise level, and obtaining the current noise level of the external environment according to a comparison result.

The current sound intensity of the first noise signal may be a current sound intensity value of the first noise signal, or may be an average value or a variance of sound intensities within a set time range. For example, a current time is t0, the set time is Δt, and the current sound intensity of the first noise signal may be an average value or a variance of sound intensities between the moment (t0-Δt) and the moment t0. In a specific embodiment of the present invention, the current sound intensity of the first noise signal is an average value of sound intensities within a set time range, so that when an instantaneous increase in a sound intensity suddenly occurs in the external environment, because the current sound intensity of the first noise signal is an average value of sound intensities within a set period of time, the instantaneously increased sound intensity has less effect on the average value, thereby effectively eliminating an interference caused by a sudden change in ambient noise.

Specifically, the set value reflecting the noise level may be a sound intensity value that defines a noise level, for example, the noise level is 0 when the sound intensity falls in a range of 0-5 dB, the noise level is 1 when the sound intensity falls in a range of 5-15 dB, the noise level is 2 when the sound intensity falls in a range of 15-30 dB, and the noise level is 3 when the sound intensity is higher than 30 dB. In this case, the set values reflecting the noise levels are 5 dB, 15 dB, and 30 dB.

The above comparison method can be implemented by using one or more comparators, and a comparator is a circuit that compares an analog voltage signal with a reference voltage. For example, if the number of the set values is one, then a two-input comparator can compare the current sound intensity of the first noise signal with the set value; if the number of the set values is two, then two two-input comparators may be used to compare the current sound intensity of the first noise signal with the set values, or a four-input comparator can be used to compare the current sound intensity of the noise with the set values. In a specific embodiment of the present invention, there are three set values, that is, 5 dB, 15 dB, and 30 dB respectively. Three two-input comparators are used to compare the current sound intensity of the first noise signal with the set values. Specifically, voltage values corresponding to 5 dB, 15 dB, and 30 dB are respectively used as reference voltage values of the three comparators, and a current voltage value corresponding to the current sound intensity value of the first noise signal is transmitted to another input end of the three comparators. Thus, when the current voltage value is greater than a corresponding reference voltage value, a corresponding comparator outputs a high level 1; when the current voltage value is less than a corresponding reference voltage value, a corresponding comparator outputs a low level 0. In this way, when the current sound intensity value is in the range of 0-5 dB, the level values output by the three comparators may be, for example, 000 respectively; when the current sound intensity value is in the range of 5-15 dB, the level values output by the three comparators may be, for example, 100 respectively; when the current sound intensity value is in the range of 15-30 dB, the level values output by the three comparators may be, for example, 110 respectively; when the current sound intensity value is greater than 30 dB, the level values output by the three comparator may be, for example, 111 respectively.

A specific method for obtaining the current noise level of the external environment may be obtaining the current noise level corresponding to the current comparison result by searching a correspondence table that reflects a correspondence between a comparison result and a noise level. For example, when the comparison result is the level values output by the three comparators, a correspondence table reflecting a correspondence between the comparison result and a noise level is set in advance, in which a noise level corresponding to a comparison result of 000 may be 0; a noise level corresponding to a comparison result of 100 is 1; a noise level corresponding to a comparison result of 110 is 2; a noise level corresponding to a comparison result of 111 is 3. In this way, it is possible to quickly obtain the current noise level of the external environment by using the comparison result.

The above comparison method may also be implemented by software control. In a specific embodiment of the present invention, for the above set values and the corresponding noise levels, the comparing the current sound intensity of the first noise signal with a set value reflecting a noise level, and obtaining the current noise level of the external environment according to a comparison result may also be:

determining whether the current sound intensity is less than the set value 5 dB, and if yes, determining that the current noise level is 0; if not, then

determining whether the current sound intensity is less than the set value 15 dB, and if yes, determining that the current noise level is 1; if not, then

determining whether the current sound intensity is less than the set value 30 dB, and if yes, determining that the current noise level is 2; if not, then determining that the current noise level is 3.

A specific method for obtaining a current noise level of an external environment according to a sound intensity of the first noise signal may also be as shown in FIG. 2, which specifically includes the following steps.

Step S201: Perform low-pass filtering processing on the first noise signal, to obtain a filtered noise signal.

The low-pass filtering processing filters out a high-frequency noise signal from the first noise signal, to obtain a filtered noise signal with a medium or low frequency. Since active noise reduction is aimed at noise signals with a medium or low frequency in the environment, filtering out the high-frequency noise signal in the first noise signal can effectively prevent a high-frequency noise signal from affecting noise reduction gain adjustment and bring a better noise reduction effect.

Step S202: Perform amplification processing on the filtered noise signal, to obtain an amplified noise signal.

As a voice signal collected by the microphone is weak, by amplifying the voice signal before comparing it with the set value, a false determination can be effectively avoided.

Step S203: Compare a current sound intensity of the amplified noise signal with a set value reflecting a noise level.

Step S204: Obtain the current noise level of the external environment according to a comparison result.

Specific methods of step S203 and step S204 are similar to the methods for comparing the current sound intensity of the first noise signal with a set value reflecting a noise level, and obtaining the current noise level of the external environment according to a comparison result, so the details are not repeated herein.

Step S103: Set a current noise reduction gain value corresponding to the current noise level.

A specific method for setting the current noise reduction gain corresponding to the current noise level may include the following steps:

searching a correspondence table that reflects a correspondence between a noise level and a noise reduction gain value, to obtain the noise reduction gain value corresponding to the current noise level; and

setting the current noise reduction gain value to be equal to the obtained noise reduction gain value.

For example, in the correspondence table that reflects a correspondence between a noise level and a noise reduction gain value, it may be, but is not limited to, preset that a noise reduction gain value corresponding to a noise level of 0 is 0; a noise reduction gain value corresponding to a noise level of 1 is 0.3; a noise reduction gain value corresponding to a noise level of 2 is 0.5; a noise reduction gain value corresponding to a noise level of 3 is 0.6.

When the external environment is quiet, if noise reduction processing is performed on noise, there will be a strong pressure on eardrums, which leads to poor user experience, and causes the earphone to consume more power and waste energy. Therefore, in an embodiment of the present invention, the method of the present invention further includes determining whether to perform noise reduction processing according to the current noise level, and if yes, performing step S103, and if not, performing no other operation. For example, when the current noise level is 0, the external environment may be considered as being quiet and noise reduction processing may not be performed. When the current noise level is not 0, noise reduction processing may be performed, and the noise reduction gain is set according to the current noise level. In this way, the power consumption of the active noise cancelling earphone can be effectively reduced, to extend its service time.

Step S104: Perform noise reduction processing according to the current noise reduction gain value.

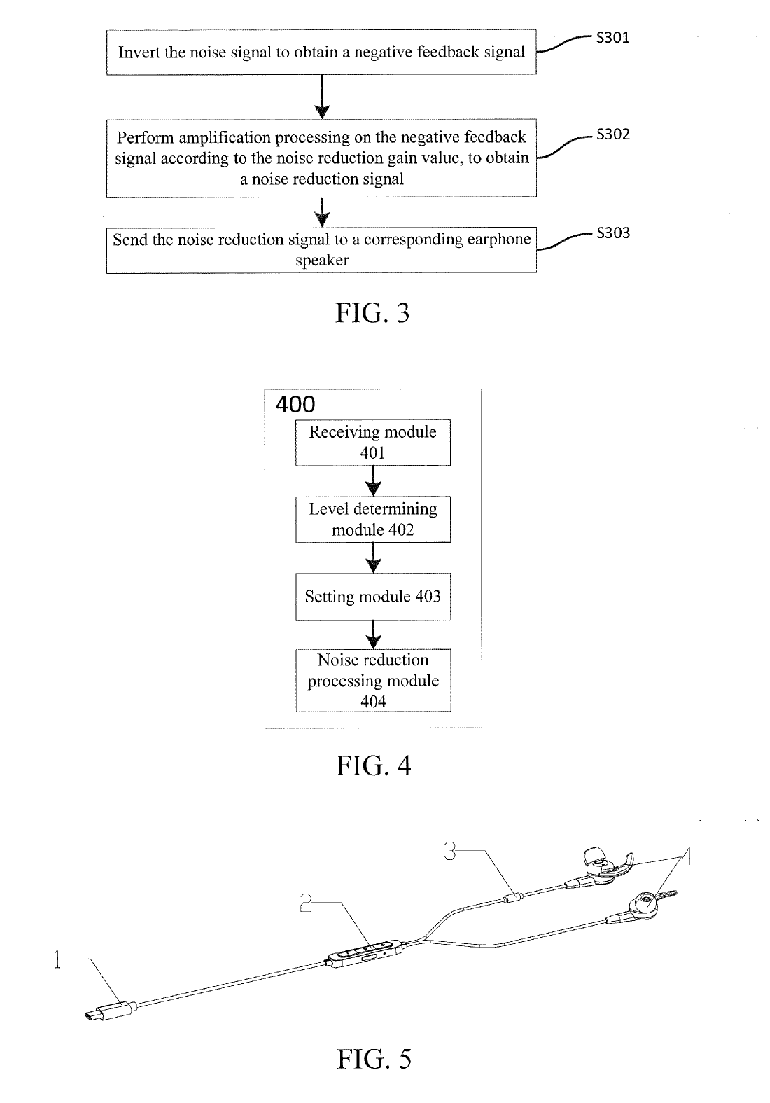

Specific steps of the noise reduction processing may be as shown in FIG. 3, including the following steps.

Step S301: Invert the noise signal to obtain a negative feedback signal.

When the two earphone receivers are provided with only one microphone, the noise signal is inverted, to obtain a negative feedback signal.

When both the earphone receivers are provided with microphones, the first noise signal is inverted to obtain a first negative feedback signal; and the second noise signal is inverted to obtain a second negative feedback signal.

Step S302: Perform amplification processing on the negative feedback signal according to the noise reduction gain value, to obtain a noise reduction signal.

When the two earphone receivers are provided with only one microphone, amplification processing is performed on the negative feedback signal according to the noise cancellation gain value to obtain the noise cancellation signal.

When both the earphone receivers are provided with microphones, if a noise reduction gain is obtained according to only the first noise signal, amplification processing may be performed on the first negative feedback signal according to the noise cancellation gain to obtain a first noise reduction signal; and amplification processing may be performed on the second negative feedback signal according to the noise reduction gain, to obtain a second noise reduction signal.

If a first noise reduction gain is obtained according to the first noise signal and a second noise reduction gain is obtained according to the second noise signal, amplification processing may be performed on the first negative feedback signal according to the first noise reduction gain to obtain a first noise reduction signal; and amplification processing may be performed on the second negative feedback signal according to the second noise reduction gain, to obtain a second noise reduction signal.

Step S303: Send the noise reduction signal to a corresponding earphone speaker.

When the two earphone receivers are provided with only one microphone, the noise reduction signal is sent to two earphone speakers.

When both the earphone receivers are provided with microphones, the first noise reduction signal and the second noise reduction signal are respectively sent to corresponding earphone speakers.

In this case, active noise reduction processing is separately performed on the first noise signal and the second noise signal, and the loudspeakers transmit the noise reduction signals of the voice signal received by the microphones in the same earphone receivers, so that the microphones and the loudspeakers installed on the two earphone receivers do not interfere with each other.

The speakers of the corresponding earphone receivers transmit the noise reduction signal with a phase opposite to that of the noise signal and an amplitude amplified according to the noise reduction gain value, a noise reduction effect can be achieved, while ensuring the comfort of eardrums, and realizing a balance therebetween.

Further, in a specific embodiment of the present invention, the noise reduction signal is first filtered before being sent to the corresponding earphone speaker, so that a signal-to-noise ratio of the voice signal can be improved, improving the voice intelligibility.

The present invention further provides a noise reduction device for adaptively adjusting a noise reduction gain. FIG. 4 is a schematic block diagram of an implementation structure of the device.

As shown in FIG. 4, the device 400 includes a receiving module 401, a level obtaining module 402, a setting module 403, and a noise reduction processing module 404. The receiving module 401 is configured to receive a voice signal collected by a microphone installed on an earphone receiver as a noise signal. The level obtaining module 402 is configured to obtain a current noise level of an external environment according to a sound intensity of the noise signal. The setting module 403 is configured to set a current noise reduction gain value corresponding to the current noise level. The noise reduction processing module 404 is configured to perform noise reduction processing on the noise signal according to the current noise reduction gain value.

Further, the device 400 further includes a determining module, configured to determine, according to the current noise level, whether to perform noise reduction processing.

The level obtaining module 402 further includes a comparison unit and an obtaining unit. The comparison unit is configured to compare the current sound intensity of the noise signal with a set value reflecting a noise level, to obtain a comparison result. The obtaining unit is configured to obtain the current noise level of the external environment according to the comparison result.

The setting module 403 further includes a searching unit and a setting unit. The searching unit is configured to search a correspondence table that reflects a correspondence between a noise level and a noise reduction gain value, to obtain the noise reduction gain value corresponding to the current noise level. The setting unit is configured to set the current noise reduction gain value to be equal to the obtained noise reduction gain value.

The present invention further provides a noise cancelling earphone. In one aspect, the noise cancelling earphone includes the foregoing noise reduction device for adaptively adjusting a noise reduction gain.

In another aspect, the noise cancelling earphone includes a memory and a processor. The memory is configured to store instructions that control the processor to operate to execute the foregoing noise reduction method for adaptively adjusting a noise reduction gain.

The processor may be, for example, a DSP digital processor or a microprocessor MCU. The memory includes, for example, a ROM (Read Only Memory), a RAM (Random Access Memory), and a non-volatile memory such as a hard disk.

In a specific embodiment of the present invention, the noise cancelling earphone of the present invention includes an earphone plug 1, a main control board 2, a call microphone 3, and an earphone receiver 4, as shown in FIG. 5.

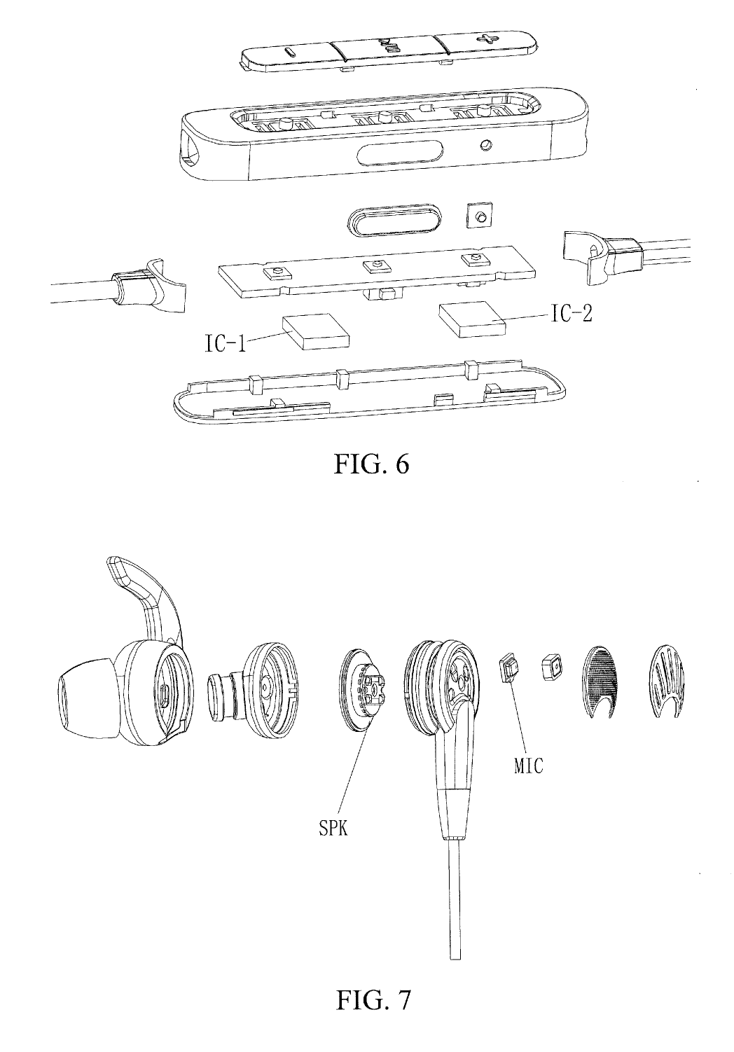

The earphone plug 1 may be, for example, a 3.5 mm plug or a type-C plug. The structure of the main control board 2 may be as shown in FIG. 6. The main control board 2 is provided with a play/pause key, a volume up key, a volume down key, and an on-off key, and further provided with an operational amplifier, a comparator, a processor IC1, and a noise reduction control chip IC2. The operational amplifier is configured to amplify a noise signal, the comparator is configured to compare a current sound intensity of the noise signal with a set value, the processor IC1 is a microprocessor MCU for executing the above noise reduction method for adaptively adjusting a noise reduction gain, and the noise reduction control chip IC2 is configured to adjust a noise reduction gain.

The call microphone 3 is used to collect a voice signal during a call of a user.

The earphone receiver 4 includes a noise reduction microphone MIC and a speaker SPK. As shown in FIG. 7, the noise reduction microphone MIC is configured to collect an ambient noise signal, and the speaker SPK is configured to play the noise cancelled voice signal.

The above embodiments mainly focus on the differences from other embodiments, but those skilled in the art should understand that the above embodiments may be used separately or in combination with each other as needed.

Although some specific embodiments of the present invention have been described in detail by way of example, those skilled in the art should understand that the above examples are only for the purpose of illustration and are not intended to limit the scope of the present invention. It will be understood by those skilled in the art that the above embodiments may be modified without departing from the scope and spirit of the present invention. The scope of the invention is defined by the appended claims.

1. A noise reduction method for self-adaptively adjusting a noise reduction gain, comprising:
receiving a voice signal collected by a microphone installed on an earphone receiver as a noise signal;
obtaining a current noise level of an external environment according to a current sound intensity of the noise signal;
setting a current noise reduction gain value corresponding to the current noise level; and
performing noise reduction processing on the noise signal according to the current noise cancellation gain value.

2. The method according to claim 1, wherein the obtaining a current noise level of an external environment according to a current sound intensity of the noise signal comprises:
comparing the current sound intensity of the noise signal with a set value reflecting the noise level, to obtain a comparison result; and
obtaining the current noise level of the external environment according to the comparison result.

3. The method according to claim 1, wherein the method further comprises:
determining, according to the current noise level, whether to perform noise reduction processing or not, if yes, setting the noise reduction gain value corresponding to the current noise level.

4. The method according to claim 1, wherein the setting a current noise reduction gain corresponding to the current noise level comprises:
searching a comparison table that reflects the relationship between the noise level and the noise reduction gain value, to obtain the noise reduction gain value corresponding to the current noise level; and
setting the current noise reduction gain value to be equal to the obtained noise reduction gain value.

5. A noise reduction device for self-adaptively adjusting a noise reduction gain, comprising:
a receiving module, configured to receive a voice signal collected by a microphone installed on an earphone receiver as a noise signal;
a level obtaining module, configured to obtain a current noise level of the external environment according to the sound intensity of the noise signal;
a setting module, configured to set a current noise reduction gain value corresponding to the current noise level; and
a noise reduction processing module, configured to perform noise reduction on the noise signal according to the current noise reduction gain value.

6. The device according to claim 5, wherein the level obtaining module comprises:
a comparison unit, configured to compare the current sound intensity of the noise signal with a set value reflecting the noise level, to obtain a comparison result; and
an obtaining unit, configured to obtain the current noise level of the external environment according to the comparison result.

7. The device according to claim 5, wherein the device further comprises:
a determining module, configured to determine, according to the current noise level, whether to perform a noise reduction.

8. The device according to claim 5, wherein the setting module comprises:
a searching unit, configured to search a comparison table that reflects the relationship between the noise level and the noise reduction gain value, to obtain the noise reduction gain value corresponding to the current noise level; and
a setting unit, configured to set the current noise reduction gain value to be equal to the obtained noise reduction gain value.

9. (canceled)

10. A noise-reduction earphone, comprising a processor and a memory, wherein the memory is configured to store instructions, and the instructions are used to control the processor to operate to execute the method according to claim 1.
